(19) United States
(12) Patent Application Publication
(10) Pub. No.: US 2012/0183762 A1
(43) Pub. Date: Jul. 19, 2012

(54) Magnetic alignment of nanoparticles within a polymer

(75) Inventors: Karl Poehlmann, Mount Dora, FL (US); Darin Marcuz, Bremen, GA (US)

(73) Assignee: Magna International Inc., Aurora (CA)

(21) Appl. No.: 12/930,717

(22) Filed: Jan. 14, 2011

(51) Int. Cl. B29C 70/62; G06F 17/50; B29C 45/17; B32B 5/16; B82Y 30/00; B82Y 40/00

(52) U.S. Cl. 428/323; 264/429; 700/104; 977/902

(57) ABSTRACT

A method for magnetically aligning non-particles within a polymer, involving adding a magnetic nano-particle filler to a plastic material, such as a molten thermoplastic. The magnetic property allows the filler or particles to be aligned through the use of magnetic fields during the molding process. In one embodiment, the nano-particles are synthesized to a specific size, and are made by applying suitable coatings to existing fillers.

### FIELD OF THE INVENTION

The present invention relates to an improvement in an injection molding process, which provides for greater predictability of shrinkage in an injection molded part, as well as improves the transfer efficiency of auto parts which make use of conductive paints.

### BACKGROUND OF THE INVENTION

Many different types of products are manufactured using an injection molding process where a thermoplastic or thermoset material is injected into a mold to form a desired part. Examples of parts made using an injection molded thermoplastic material include, but are not limited to, fascia, bumpers, door panels, rocker panels, and the like. The thermoplastic material is typically a polymer, and reinforcing fillers or particles are often used to reinforce the polymer matrix, improving physical properties (such as strength) and/or reducing cost. Various methods have been developed to improve the process of designing a molded part, such as using mold flow analysis software which predicts flow and shrink characteristics after the injected material is de-molded and the part is in a free state. Mold flow analysis involves modeling solid, liquid, and gas flow based on individual elements of the molten material being injected into the mold. This is known as finite element analysis. An example of an individual element is a solid particle within the polymer matrix of the polymer. The individual elements combine to comprise the entire part.

One of the problems common with injection molded parts is that misaligned or randomly oriented reinforcing fillers or particles result in poor predictability of molded plastic part dimensions which adds cost to design and validation efforts.

Furthermore, injection molded parts commonly experience shrinkage as the molten material cools in the mold and changes into a solid material. One problem resulting from the use of mineral fillers or particles in polymers (plastics) is the occurrence of non-uniform shrinkage in molded plastic parts. Along with other factors, particle aspect ratio (i.e., size) and orientation of the filler or particles in the polymer affect shrinkage in the molded part. In the instance of more complex-shaped parts, the prediction of shrinkage during the tool design phase requires finite element analysis. Using finite element analysis accounts for particle size and orientation within the polymer and provides for a prediction as to how a molded part may shrink to the required final dimensions.

Because of the complexity of filler or particle alignment during tool-fill or injection of the molten material into the mold, simplifying assumptions with regard to shrinkage are often made to reduce design and development costs. Those assumptions can result in costly tooling adjustments later on in the design validation phase to make the part match to the print. If the assumptions are incorrect, the tool or die may need to be reshaped, increasing production costs.

Accordingly, there exists a need for an improvement in orienting the fillers or particles during the molding process to provide better control over shrinkage characteristics, thereby reducing tooling adjustments of an injection mold.

### SUMMARY OF THE INVENTION

The present invention is directed to a method for magnetically aligning nano-particles within a polymer. The present invention involves adding a magnetic nano-particle filler to a plastic material, such as a molten thermoplastic. The magnetic property allows the filler or particles to be aligned through the use of magnetic fields during the molding process. In one embodiment, the nano-particles are synthesized to a specific size. This provides the advantage of the nano-particles being uniform in size.

In another embodiment, the nano-particles are made by applying suitable coatings to existing fillers. The advantage of using existing mineral fillers would be lower initial cost, but with the disadvantage of size variation. In either case, a magnetic coating is applied to the particles.

It is an object of the present invention to align filler particles (within the polymer) in a predictable manner to simplify the determination of shrink characteristics. This reduces design time and validation iterations of the mold to achieve a molded plastic part which meets customer expectations. Additionally, for parts which use conductive paints, the present invention improves the transfer efficiency of the conductive paint, reducing or eliminating the need for primer paints.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a mold and a generator device used for an injection molding process, according to the present invention;

FIG. 2 is a perspective view of an element of a molten material having a filler particle, used during an injection molding process, according to the present invention;

FIG. 3 is an enlarged view of a section of a part made using an injection molding process prior to the filler particles being aligned, according to the present invention; and

FIG. 4 is an enlarged view of a section of a part made using an injection molding process after the filler particles have been aligned, according to the present invention.

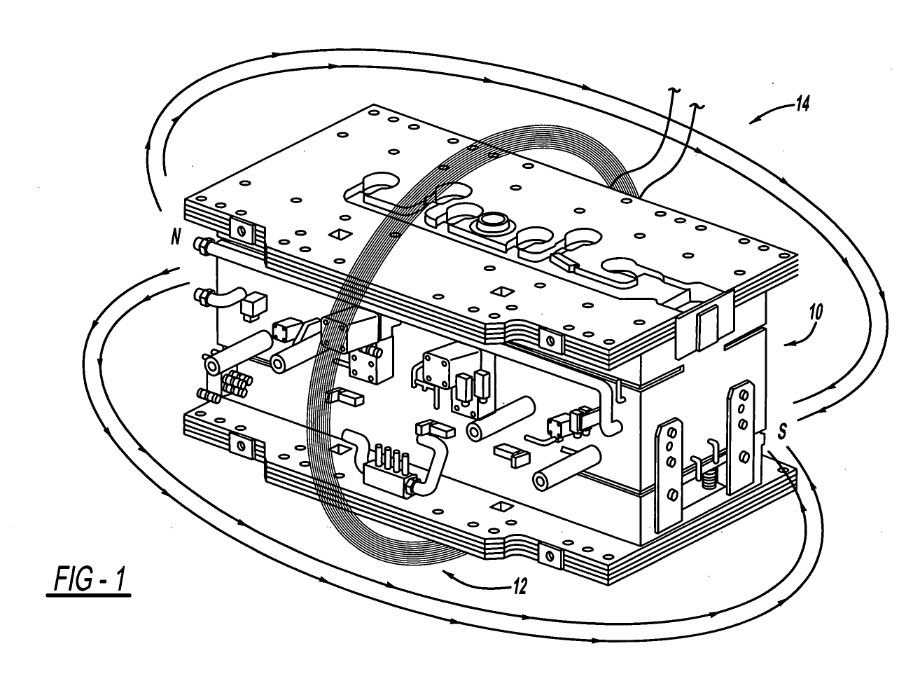

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures generally, a mold used during an injection molding process according to the present invention is shown generally at 10. Adjacent the mold 10 is a generator device 12 which is capable of creating a magnetic field around the mold 10. In this embodiment, the generator device 12 is a coil of wires connected to a device for providing a current through the wires, and is a separate component relative to the mold 10. However, it is within the scope of the invention that the generator device 12 may be integrated with the mold 10 such that the generator device 12 and mold 10 are a single component. In an alternate embodiment, the generator device 12 is a pair of permanent magnets located on each side of the mold; in yet another embodiment, the generator device 12 is an electromagnet located inside the mold.

The generator device 12 is capable of generating a magnetic field, shown generally at 14. The magnetic field 14 flows from a north pole, indicated at N, to a south pole, indicated at S. The generator device 12 produces the magnetic field 14 to properly align a plurality of particles, shown generally at 16.

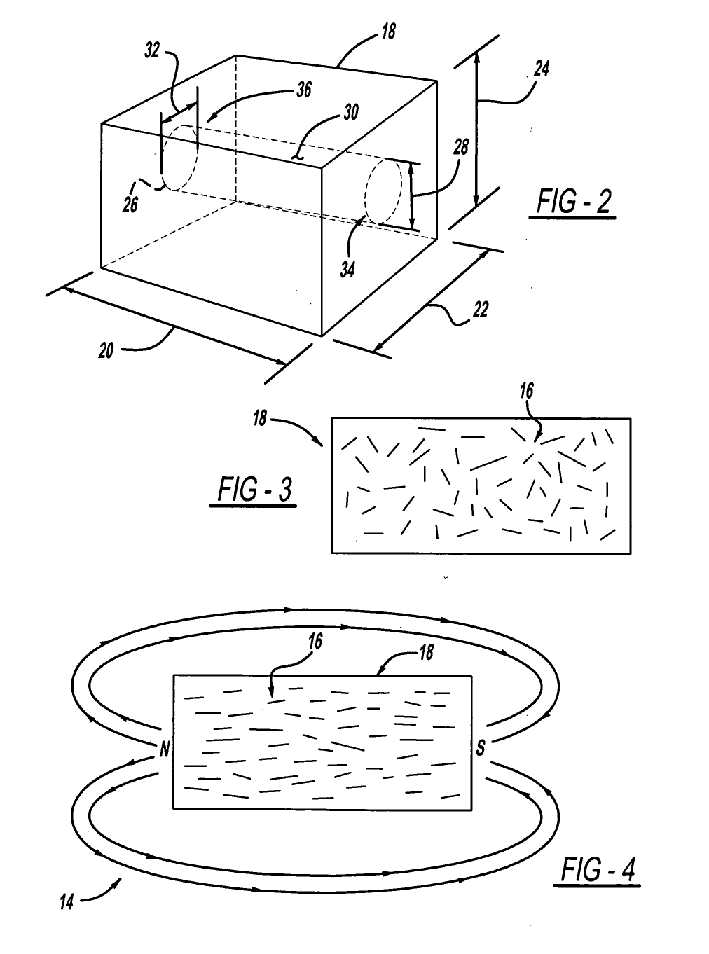

Referring to FIG. 2, an element 18 of a component made using an injection molding process according to the present invention is shown. The element 18 represents an infinitesimally small part of the component used in a finite element analysis (FEA), but may represent a larger portion of the component, depending upon the type of FEA used. A larger amount of elements 18, with the elements 18 being smaller, requires a larger amount of time to complete the FEA, but yields a more accurate prediction as to how much the component produced in the mold 12 undergoes shrinkage. A smaller amount of elements 18, with each element 18 being larger in size, requires a shorter amount of time to complete the FEA, but yields a less accurate prediction as to the amount of shrinkage the component produced in the mold 12 may have upon completion.

Each element 18 includes a length 20, a width 22, and a height 24. Located within each element 18 is a magnetically interactive particle or filler 26. The particle 26 has an oval or circular cross-section which includes a height 28 and a width 32, with the height 28 being less than, equal to, or greater than the width 32. The length of the particle 26 is substantially the same as the length 20 of the element 18, and each particle 26 has a first end 34 and a second end 36. In this embodiment, the element 18 is said to have an aspect ratio which is calculated in one of several ways, depending upon the height 28 and the width 32 of the particle 26. If the height 28 and the width 32 of the particle are equal, the aspect ratio is the length 20 of the element 18 divided by the width 32 of the particle 26.

If the width 32 and the height 28 are not equal, then the aspect ratio is calculated by dividing the length 20 of the element 18 by the average cross-sectional dimension of the width 32 and height 28. More specifically, the width 32 and the height 28 are added together and divided in half to give the average cross-sectional dimension, and the length 20 is divided by the average cross-sectional dimension. It is within the scope of the invention that various aspect ratios may be used, such as, but not limited to, between 1:1 and 20:1. In this embodiment, the particle 26 is made from wollastonite, a type of calcium inosilicate mineral, but it is within the scope of the invention that other types of materials may be used as the filler material.

In one embodiment, the particles 26 are of different sizes, and each particle 26 has a magnetic coating 30. During injection, the molten material, which is made up of the elements 18, is injected into the mold 10, and the particles 26 are in a random configuration, best seen in FIG. 3. While the molten material is still soft and has not hardened after cooling, the generator device 12 is activated to generate the magnetic field 14 which substantially aligns the particles 26, best seen in FIG. 4. In one embodiment, the first end 34 aligns with the south pole S of the magnetic field 14, and the second end 36 is aligned with the north pole N of the magnetic field 14, best shown in FIG. 4. Once the particles 26 are aligned, as the molten material in the mold 10 begins to cool and shrink, the molten material shrinks more in the direction of the width 22 and less in the direction of the length 20. The alignment of the particles 26 provides for better control of the shrinkage of the component after it is finished and removed from the mold 10. The amount of shrinkage in each direction is controlled by the alignment of the particles 26. This reduces the amount of adjustments that may need to be made to the mold 10 to compensate for shrinkage, thereby reducing the cost of producing the mold 10. Furthermore, for parts which are painted with a conductive paint, the present invention improves the transfer efficiency of the conductive paint, reducing or eliminating the need for primer paints.

In another embodiment, the particles 26 are synthesized to be of the same size, but still have the magnetic coating such that the particles 26 align when exposed to a magnetic field, as with the first embodiment. Furthermore, while the size of the particles 26 may be synthesized to be consistent relative to one another, the particles 26 may be synthesized such that all of the particles 26 are larger or smaller (but are still the same size relative to one another) to change the way the component shrinks in the mold 10 during cooling.

In yet another embodiment, magnetic nanoparticles are used either alone or in conjunction with the above coated particles to provide shrinkage control. Useful particles are selected from the group of: iron oxide nanoparticles, nickel zinc ferrite nanoparticles, ferrous ferric oxide nanoparticles, ferrite nanoparticles having the formula MFeO₄, wherein M is a divalent metal, preferably Ni or cobalt; magnetic nanowires including aligned magnetic nanowires; nanoparticles coated with any of these materials, and mixtures thereof.

Typically, nanoparticles useful in the present invention are less than about one micrometer, and generally from about one to about 2500 nanometers, and preferably from about one to about 100 nanometers. In one embodiment, the particle size ranges from one nanometer to 20,000 nanometers.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A method for controlling the amount of shrinkage during an injection molding process, comprising the steps of:
a mold having a cavity operable for receiving a molten material;
a generator device operable for creating a magnetic field;
at least one magnetically interactive nanoparticle disposed in said molten material;
injecting said molten material into said mold;
creating a magnetic field in proximity to said mold with said generator device; and
aligning said at least one magnetically interactive particle with said magnetic field such that as said molten material cools, said molten material shrinks in a first manner in one direction, and a second manner in a second direction.

2. The method for controlling the amount of shrinkage during an injection molding process of claim 1, wherein said at least one magnetically interactive nanoparticle is a particle coated with a magnetic coating such that said at least one magnetically interactive nanoparticle is aligned by a north pole and a south pole of said magnetic field when said magnetic field is created by said generator device.

3. The method for controlling the amount of shrinkage during an injection molding process of claim 1, wherein said magnetically interactive nanoparticle is one selected from the group consisting of: iron oxide nanoparticles, nickel zinc ferrite nanoparticles, ferrous ferric oxide nanoparticles, ferrite nanoparticles having the formula MFeO4, wherein M is a divalent metal, such as Ni or cobalt; magnetic nanowires including aligned magnetic nanowires;
nanoparticles coated with any of these materials, and mixtures thereof

4. The method for controlling the amount of shrinkage during an injection molding process of claim 3, wherein said magnetically interactive nanoparticle is of a size of less than about one micrometer.

5. The method for controlling the amount of shrinkage during an injection molding process of claim 4, wherein said magnetically interactive nanoparticle is of a size from about one nanometer to about 2500 nanometers.

6. The method for controlling the amount of shrinkage during an injection molding process of claim 5, wherein said magnetically interactive nanoparticle is of a size from about one nanometer to about 100 nanometers.

7. The method for controlling the amount of shrinkage during an injection molding process of claim 1, further comprising the steps of:
providing said molten material to be made up of at least one element, said at least one element having a length and a width;
providing said at least one magnetically interactive nanoparticle to have a first end and a second end, said at least one magnetically interactive nanoparticle having a length substantially equal to the length of said at least one element; and
disposing said at least one magnetically interactive nanoparticle within said at least one element such that when said magnetic field is created by said generator device, said first end of said at least one magnetically interactive nanoparticle is attracted to a south pole of said magnetic field and said second end of said at least one magnetically interactive nanoparticle is attracted to a north pole of said magnetic field.

8. The method for controlling the amount of shrinkage during an injection molding process of claim 7, further comprising the steps of said width of each of said at least one element shrinks by a greater amount compared to said length of said at least one element as said molten material shrinks in said mold.

9. The method for controlling the amount of shrinkage during an injection molding process of claim 7, further comprising the steps of:
providing said at least one magnetically interactive nanoparticle to be further comprised of a plurality of particles; and
providing said at least one element to be further comprised of a plurality of elements forming said molten material, each one of said plurality of particles disposed in one of said plurality of elements such that when said magnetic field is created by said generator device, the first end of each of said plurality of particles are attracted to said south pole of said magnetic field, and second end of each of said plurality of particles are attracted to said north pole of said magnetic field.

10. The method for controlling the amount of shrinkage during an injection molding process of claim 1, further comprising the steps of providing each of said plurality of particles to be substantially the same size.

11. A method for controlling the amount of shrinkage during an injection molding process, comprising the steps of:
providing a plurality of particles, each of said plurality of particles having a first end and a second end;
providing a molten material made up of a plurality of elements, each one of said plurality of particles disposed in a corresponding one of said plurality of elements;
providing a mold having a cavity operable for receiving said molten material;
providing a generator device operable for creating a magnetic field in proximity to said mold;
providing a magnetic coating around each of said plurality of particles; and
generating a magnetic field with said generator device in proximity to said mold such that said each of said plurality of particles substantially aligns with one another.

12. The method for controlling the amount of shrinkage during an injection molding process of claim 11, further comprising the steps of:
providing a north pole, said north pole being part of said magnetic field such that when said generator device creates said magnetic field, said second end of each of said plurality of particles is attracted to said north pole of said magnetic field; and
providing a south pole, said south pole being part of said magnetic field such that when said generator device creates said magnetic field, said first end of each of said plurality of particles is attracted to said south pole of said magnetic field.

13. The method for controlling the amount of shrinkage during an injection molding process of claim 11, further comprising the steps of providing each of said plurality of elements to have a length and a width, such that the length of each of said plurality of particles is substantially the same as the length of each of said plurality of elements.

14. The method for controlling the amount of shrinkage during an injection molding process of claim 13, further comprising the steps of said width of each of said plurality of elements shrinks by a greater amount compared to said length of each of said plurality of elements as said molten material shrinks in said mold.

15. The method for controlling the amount of shrinkage during an injection molding process of claim 11, further comprising the steps of synthesizing each of said plurality of particles such that each of said plurality of particles are the same size.

16. A component for an automobile created using an injection molding process, comprising:
a molten material having a plurality of elements;
a plurality of particles, each of said plurality of particles having a first end and a second end, each one of said plurality of particles disposed in one of said plurality of elements; and
a magnetic material each of said plurality of particles coated by said magnetic material;
wherein each of said plurality of particles is exposed to a magnetic field, thereby aligning each of said plurality of particles relative to one another, thereby controlling the amount of shrinkage of said molten material when said molten material flows into a mold.

17. The method for controlling the amount of shrinkage during an injection molding process of claim 16, further comprising:
a generator device operable for creating said magnetic field, said magnetic field having a north pole and a south pole;
a cavity formed as part of said mold, said cavity operable for receiving said molten material, said generator device positioned in proximity to said mold;
wherein said magnetic field is generated by said generator device such that said first end of each of said plurality of particles is attracted to said south pole of said magnetic field, and said second end of each of said plurality of particles is attracted to said north pole of said magnetic field, thereby substantially aligning said plurality of particles relative to one another.

18. The method for controlling the amount of shrinkage during an injection molding process of claim 16, further comprising each of said plurality of elements having a length and a width, such that the length of each of said plurality of particles is substantially the same as said length of said plurality of elements, wherein said width of each of said plurality of elements shrinks by a greater amount compared to said length of each of said plurality of elements as said molten material shrinks in said mold.

19. The method for controlling the amount of shrinkage during an injection molding process of claim 16, wherein each of said plurality of particles is synthesized such that each of said plurality of particles are the same size.

20. A method for reducing the number of validation iterations during the creation of a mold for an injection molding process, comprising the steps of:
providing a plurality of particles, each of said plurality of particles having a first end and a second end;
providing a molten material made up of a plurality of elements, each of said plurality of elements having a length and a width, each one of said plurality of particles disposed within a corresponding one of said plurality of elements; and
modeling the mold flow characteristics of said molten material with a mold flow analysis software based on the assumption that said plurality of particles are in substantial alignment in relation to one another, reducing the number of validation iterations needed during the construction of said mold.

21. The method for reducing the number of validation iterations during the creation of a mold for an injection molding process of claim 20, further comprising the steps of providing the assumption that each of said plurality of elements shrinks by a larger amount along said width compared to said length.

22. The method for reducing the number of validation iterations during the creation of a mold for an injection molding process of claim 20, further comprising the steps of providing said mold flow analysis software to be finite element analysis.

23. The method for reducing the number of validation iterations during the creation of a mold for an injection molding process of claim 20, further comprising the steps of:
providing a generator device operable for creating a magnetic field in proximity to said mold; and
coating each of said plurality of particles with a magnetic coating such that said first end of said plurality of particles is attracted to a south pole of said magnetic field, and said second end of said at least one particle is attracted to a north pole of said magnetic field.

24. The method for reducing the number of validation iterations during the creation of a mold for an injection molding process of claim 20, further comprising the steps of providing each of said plurality of particles to be substantially the same size.
